(19) United States
(12) Patent Application Publication
(10) Pub. No.: US 2021/0017324 A1
(43) Pub. Date: Jan. 21, 2021

(54) POLYURETHANE FOAM SYSTEM

(71) Applicant: Dow Global Technologies LLC, MIdland, MI (US)

(72) Inventors: Stefano Carlo E Grassini, Schindellegi (CH); Adrian J. Birch, Kempraten-Jona (CH); Karja Oswald, Schindellegi (CH)

(21) Appl. No.: 16/771,000

(22) PCT Filed: Oct. 17, 2018
(86) PCT No.: PCT/US2018/056262

§ 371 Date: Jun. 9, 2020

Related U.S. Application Data
(60) Provisional application No. 62/584,167, filed on Nov. 10, 2017.

(51) Int. Cl. C08G 18/20; C08G 18/32; C08G 18/48; C08G 18/76

(52) U.S. Cl. CPC C08G 18/2027; C08G 18/3275; C08G 2101/0008; C08G 18/7664; C08G 18/4816

(57) ABSTRACT

A reactive polyurethane foam-forming composition including (I) an isocyanate-containing material; and (II) a polyol-containing admixture of: (a) at least one autocatalytic polyol; (b) at least one grafted polyol; (c) at least one reactive polyether polyol; (d) at least one reactive catalyst; (e) at least one surfactant; and (f) water; and a process for making the above foam-forming composition.

### REFERENCE TO RELATED APPLICATIONS

The present application claims the benefit of U.S. Provisional Application No. 62/584,167, filed on Nov. 10, 2017.

### FIELD

The present invention relates to a foam-in-place polyurethane foam system and a method for preparing a foam from such system.

### BACKGROUND

Flexible polyurethane foams are well recognized articles of commerce; and various polyurethane foam systems are known for producing flexible polyurethane foams for a wide variety of commercial applications such as in cushioning, seating, bedding, furniture, transportation interiors, carpet underlay, and packaging applications. Generally, reaction mixtures of polyols, polyisocyanates, catalysts and/or other additives are used to prepare foam-forming polyurethane reaction mixture compositions which, in turn, can be used to produce flexible polyurethane foams. However, there is an enormous variation in the compositional features of isocyanate compounds and the hydroxyl compounds use to prepare polyurethane foams; and when the isocyanate groups of the isocyanate compound react with the hydroxyl groups of the hydroxyl compound to form urethane linkages, a large number of polyurethane foam structures and performance profiles can result. Rigid foams, flexible foams and acoustic low-density foams are some examples of types of foam produced in the industry.

In some foam systems, even a slight change in concentration of the compounds used in the system can provide a foam system that has a different structure and that performs differently. In other foam systems, a change in a specific component used in the foam system can also provide a different foam product that may or may not perform adequately for the application desired. Thus, not all foam system compounds or dosages of foam system compounds perform alike to provide a workable foam system or to provide a foam product with adequate properties for a particular type of application.

For example, EP2039713B1 discloses foams made with amine-initiated autocatalytic polyols. In some cases, substituting an autocatalytic polyol for a different autocatalytic polyol can change the performance of the foam system. It has been surprisingly found that not all autocatalytic polyols perform alike to provide a workable foam system or to provide a foam product with adequate properties.

U.S. Provisional Patent Application No. 62/449234, entitled “Flexible Polyurethane Foam and Process to Make,” filed Jan. 23, 2017 by Grassini et al, (Attorney Docket No. 80240), discloses a resilient polyurethane foam product which exhibits very little change in compression set across a wide range of isocyanate indices. The above patent application further discloses the use of an autocatalytic polyol in combination with an amine-based urethane gelling catalyst such as RZETA™ (1,4-diazabicyclol2.2.2loctane-2-methanol available from Tosoh Corporation) in the foam system to produce a low emission foam product.

Some of the disadvantages encountered with the use of the above known foam systems include for example, the resulting foam products produced with the known systems do not exhibit advantageous processing properties such as fast reactivity and fast demolding while still maintaining reduced emissions behavior. In addition, preparing a “fast reactivity and fast demolding foam in place polyurethane foam” using a low emission catalyst in a foam system is challenging because of the large amount of total catalyst required to be used in such foam system as compared to other polyurethane foam systems used for other applications.

### SUMMARY

One aspect of the present invention is directed to a polyurethane foam-forming reaction mixture composition or system that advantageously is fast reacting, is fast demolding, has good processability, has a wide hardness range and exhibits reduced emissions that passes the VDA 278 (2015) emissions test. In one embodiment, the polyurethane foam-forming reaction mixture composition of the present invention includes: (I) an organic isocyanate -containing material, component (I), comprising (α) at least one polyisocyanate compound and/or (β) at least one prepolymer containing at least one isocyanate group; and (II) a polyol-containing admixture of: (a) at least one autocatalytic polyol; (b) at least one grafted polyol; (c) at least one reactive polyether polyol; (d) at least one reactive catalyst; (e) at least one surfactant; and (f) water; a process for making the above foam-forming composition; and a polyurethane foam prepared from the above polyurethane foam-forming reaction mixture composition.

Another aspect of the present invention is directed to a process for making the above polyurethane foam-forming reaction mixture composition. In one embodiment, the polyurethane foam-forming composition or system exhibits advantageous processing properties such as (1) fast demolding time, (2) good flow, and (3) low emissions according to VDA 278 (2015) emission test.

Still another aspect of the present invention is directed to a polyurethane foam prepared from the above polyurethane foam-forming reaction mixture composition. In one embodiment, the polyurethane foam-forming composition is useful for producing a flexible polyurethane foam via a foam-in-place (FIP) process such that the foam system exhibits an ultra-fast demolding time (e.g., a maximum of about 20 seconds); and, at the same time, such that the foam system is able to pass the VDA 278 (2015) emission test and show a self-crushing behavior (open cells structure). The flexible polyurethane foam of the present invention advantageously can be used for filling vehicle components such as headrests and armrests; and since the foam is self-opening no shrinkage of the resultant foam arises in the vehicle components after the foam exotherm cools.

### DETAILED DESCRIPTION

The present invention provides a polyurethane foam system for producing a flexible polyurethane foam that exhibits a certain set of sufficient processability properties for various applications. For example, the desired foam properties or performance of the foam system can include (1) a fast reactivity/fast demolding time, (2) good flow, and (3) low emissions. In one embodiment of the present invention, a particular selection, combination, and dosage of components is used to form the polyurethane foam system that exhibits the above beneficial properties and/or performance and provides a FIP flexible polyurethane foam. Generally, a foam system for specific automotive applications is typically required to exhibit reduced emissions behavior to meet the different OEMs emission tests, e.g. VDA 278(2015) which includes a VOC upper maximum target of less than (≤) 250 μg/g and a FOG upper maximum target of ≤400 μg/g. The present invention foam beneficially meets the above targets.

In general, the polyurethane foam-forming reactive composition of the present invention is prepared by combining one or more polyols with one or more organic isocyanates. In preparing the flexible polyurethane foam of the present invention, an A-side material and a B-side material are reacted together, wherein the A-side material includes at least one isocyanate-containing component, usually a blend (α) at least one polyisocyanate compound and/or (β) at least one prepolymer containing at least one isocyanate group (herein Component (I)); and the B-side material includes at least one polyol-containing component, usually a blend of at least one polyol , at least one reactive catalyst, at least one surfactant, and water (herein Component (II)). In one broad embodiment, the present invention includes a reactive polyurethane foam-forming reaction mixture composition or system including: (I) at least one or more organic isocyanate -containing materials and other optional additives (A-side material); and (II) a polyol-containing admixture of: (a) at least one or more autocatalytic polyols; (b) at least one or more grafted polyols; (c) at least one or more reactive polyether polyols; (d) at least one reactive catalyst; (e) at least one surfactant; and (f) water and other optional additives (B-side material).

In one illustrative embodiment, the polyurethane foam system of the present invention includes a polyurethane foam-forming reaction mixture composition including: (I)) at least one prepolymer containing at least one isocyanate group; and (II) an admixture of: (a) from about 1 weight percent (wt %) to about 65 wt % of an autocatalytic polyol; (b) from about 5 wt % to about 50 wt % of at least one or more grafted polyols; (c) from about 1 wt % to about 40 wt % of at least one or more reactive polyether polyols; (d) from about 0.1 wt % to about 5 wt % of at least one reactive catalyst; (e) from about 0.1 wt % to about 5 wt % of a surfactant; and (f) from about 1 wt % to about 15 wt % of water.

The organic isocyanate -containing material, component (I), useful in the present invention may include (a) at least one polyisocyanate compound and/or (β) at least one prepolymer containing at least one isocyanate group. For example, suitable organic isocyanates, component (I)(α), useful for making the foam-forming composition and for carrying out the process of manufacturing the foam-forming composition of the present invention may include any of the organic isocyanates known in the art for preparing polyurethane foams. For example, the organic isocyanates which may be used in the present invention include aliphatic, cycloaliphatic, arylaliphatic and aromatic isocyanates. In one embodiment, aromatic isocyanates, especially aromatic polyisocyanates, are generally preferred based on cost, availability and the properties the aromatic polyisocyanates impart to the product polyurethane.

The aromatic polyisocyanates useful in producing the polyurethane foam of the present invention may include for example aromatic diisocyanates, such as methylene diphenyl diisocyanate (“MDI”) and toluene diisocyanate (“TDI”), as well as oligomers or polymers thereof. Specific exemplary polyisocyanates useful in the present invention include, for example, m-phenylene diisocyanate; 2,4- and 2,6-toluene diisocyanate; 4,4′-, 4,2′ and 2,2′-diphenyl methane diisocyanate; the various isomers of diphenyl methane diisocyanate; blends of MDI and polymeric and monomeric MDI blends; blends of MDI and TDI; hexamethylene-1,6-diisocyanate; tetramethylene-1,4-diisocyanate; cyclohexane-1,4-diisocyanate; hexahydro toluene diisocyanate; hydrogenated MDI (H₁₂ MDI); naphthylene-1,5-diisocyanate; methoxyphenyl-2,4-diisocyanate; 4,4′-biphenylene diisocyanate; 3,3′-dimethoxy-4,4′-biphenyl diisocyanate; 3,3′-dimethyldiphenylmethane-4,4′-diisocyanate; 4,4′, 4″-triphenylmethane tri-isocyanate; polymethylene polyphenylisocyanates or mixtures thereof with MDI (polymeric MDI); hydrogenated polymethylene polyphenylisocyanates; toluene-2,4,6-triisocyanate; 4,4′-dimethyl diphenylmethane-2,2′, 5,5′-tetraisocyanate; biuret modified TDI's, polymerized isocyanates, m- and p-phenylene diisocyanate, chlorophenylene-2,4-diisocyanate, and diphenylether diisocyanate and 2,4,4′-triisocyanatodiphenylether; saturated analogues of the above mentioned aromatic isocyanates; mixtures thereof; and the like.

Of the above polyisocyanates useful in the present invention, preferred are TDI and derivatives thereof; MDI and derivatives thereof; and mixtures thereof. For example, in one preferred embodiment, the organic isocyanate useful in the flexible foam-forming polyurethane composition of the present invention may be 2,4-toluene diisocyanate, 2,6-toluene diisocyanate, a mixtures of 2,4-toluene diisocyanate and 2,6-toluene diisocyanate; 2,4′-diphenylmethane diisocyanate, 2,2′-diphenylmethane diisocyanate, 4,4′-diphenylmethane diisocyanate, a mixture of 2,4′-diphenylmethane diisocyanate, 2,2′-diphenylmethane diisocyanate, 4,4′-diphenylmethane diisocyanate; and mixtures thereof. In another preferred embodiment, the polyisocyanates useful in the foam-forming composition of the present invention may include derivatives of MDI such as biuret-modified “liquid” MDI products and polymeric MDI, as well as mixtures of the 2, 4- and 2, 6-isomers of TDI.

A crude polyisocyanate may also be used in the practice of the present invention, such as crude toluene diisocyanate obtained by the phosgenation of a mixture of toluene diamine or the crude diphenylmethane diisocyanate obtained by the phosgenation of crude methylene diphenylamine

The allicyclic polyisocyanates useful in producing the polyurethane foam of the present invention may include for example isophorone diisocyanate; cyclohexane 1,4-diisocyanate; 4,4′-dicyclohexylmethane diisocyanate; and mixtures thereof.

The aliphatic polyisocyanates useful in producing the polyurethane foam of the present invention may include for example ethylene diisocyanate; 1,6-hexamethylene diisocyanate; and mixtures thereof.

Modified polyisocyanates such as carbodimide-modified polyisocyanates are also useful in producing the polyurethane foam of the present invention.

Still other preferred embodiments of the polyisocyanate useful in the present invention include for example a polymeric MDI such as VORANATE™ M229; or a mixture of TDI isomers with MDI wherein the TDI isomers constitutes from about 60 wt % to about 90 wt % based on the weight of the mixture, and in which the 2,4-TDI isomer constitutes at least about 70 wt % based on the weight of the TDI isomers such as VORANATE™ TM-20. The above VORANATE™ products are available from The Dow Chemical Company.

Exemplary of suitable prepolymers, component (Iβ), useful for making the foam-forming composition of the present invention may include free isocyanate-containing prepolymers derived by reacting a polyol with any of the above-described polyisocyanates. For example, MDI or TDI based prepolymers can be used, made either with any of the polyols as described herein below. Isocyanate-terminated prepolymers are prepared by reacting an excess of polyisocyanate with polyols, including aminated polyols or imines/enamines thereof, or polyamines. Any of the MDI prepolymers described herein are the preferred isocyanates used in the present invention.

In one embodiment, the organic isocyanate-containing material or mixture thereof, in general, can have an average of about 1.8 or more isocyanate groups per molecule. In another embodiment, the isocyanate functionality may be from about 1.9 to about 4, from about 1.9 to about 3.5 in still another embodiment, and from about 1.9 to about 2.7 in yet another embodiment.

The amount of isocyanate-containing material that may be used in the flexible foam-forming polyurethane composition of the present invention generally can be an amount that is sufficient to provide an isocyanate index of from about 60 to about 125 in one embodiment. In another embodiment, the isocyanate index range may be from about 70 to about 115 and in still another embodiment, the isocyanate index range may be from about 80 to about 105. “Isocyanate index” herein means a value that is 100 times the ratio of isocyanate groups to isocyanate-reactive groups in a formulation.

Component (II), also referred to as the B-side material, of the foam-forming polyurethane composition is a blend or admixture of components including at least one polyol compound and generally two or more polyol compounds. In a general embodiment, to prepare the foam-forming polyurethane composition, the B-side material includes a polyol-containing admixture or blend including: (a) an autocatalytic aromatic polyol, (b) a grafted polyol, and (c) a reactive polyether polyol; and other additives (described in detail herein below) including (d) at least one reactive catalyst; (e) at least one surfactant; and (f) water.

The polyol blend useful in the present invention may include an autocatalytic polyol compound, such as those disclosed in U.S. Pat. Nos. 8,957,123; 7,361,695; 6,762,274; 6,924,321; and 9,611,351, and WO2015/153316A1 all of which are incorporated in their entirety herein by reference. In one embodiment, the autocatalytic polyol compound is a polyol containing at least one tertiary amine group having a functionality of about 1 to about 8, preferably about 2 to about 8, more preferably about 2 to about 6, and a hydroxyl number of from about 15 to about 200. Aliphatic or aromatic amine based polyether polyols may be used in the present invention include those made from reacting an aliphatic or an aromatic amine with one or more alkylene oxides.

In one embodiment, the autocatalytic polyol useful in the process of the present invention is an autocatalytic polyol compound having a functionality in the range of about 2 to about 8 and a hydroxyl number in the range of about 15 to about 200, wherein said autocatalytic polyol compound comprises at least one tertiary amine group, and said autocatalytic polyol being an amine initiated polyol obtained by alkoxylation of at least one initiator molecule selected from the group consisting of 3,3′-diamino-N-methyldipropylamine, 2,2′-diamino-N-methyldiethylamine, 2,3-diamino-N-methyl-ethyl-propylamine, or a mixture thereof.

In another embodiment, the autocatalytic polyol useful in the process of the present invention is an autocatalytic polyol compound based on an initiator of the following Formula (I):

Hₘ A-(CH₂)ₙ —(N(R)—(CH₂)ₚ —AHₘ Formula (I)

where in Formula (I), n and p are independently integers from 2 to 6; A at each occurrence is independently oxygen, nitrogen or hydrogen, with the proviso that only one of A can be hydrogen at one time; R is a C₁ to C₃ alkyl group; and m is equal to 0 when A is hydrogen, is equal to 1 when A is oxygen, and is equal to 2 when A is nitrogen.

In another embodiment, the autocatalytic polyol useful in the process of the present invention is an autocatalytic polyol compound as described in U.S. Pat. No. 6,924,321, incorporated herein by reference. The autocatalytic polyol compound may be obtained by alkoxylation of an initiator of the following Formula (II):

H₂N—(CH₂)ₙ—N(R)—H Formula (II)

where in Formula (II), n is an integer from, 2 to 12, and R is a C₁ to C₃ alkyl group.

In a preferred embodiment of Formula (II), n may be an integer of 2 to 12, preferably 2 to 6, and more preferably 2 to 4. In another preferred embodiment, R may be methyl and n may be an integer of 2 to 4. Compounds of Formula (II) can be made by standard procedures known in the art. Examples of compounds of Formula II include N-methyl-1,2-ethanediamine and N-methyl-1,3-propanediamine

In still another embodiment of the present invention, polyether polyols and polyurethane polymers can be produced using an initiator composition as described in WO2015/153316 A1, incorporated herein by reference. For example, the initiator composition inay be a reaction product of a dihydroxy tertiary amine and a polyhydroxy alcohol. In a preferred embodiment, the dihydroxy tertiary amine used in the present invention has the following structure of Formula (III):

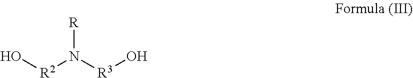

wherein R¹ is hydrogen or a C₁-C6 linear or branched alkyl group; and R² and R³ are independently a C₁-C6 linear or branched alkyl group. in another preferred embodiment, the dihydroxy tertiary amine may be an N-methyl diethanolamine (MDEA).

Suitable polyhydroxy alcohols useful in the present invention may include for example alcohols having from 2 to 8 hydroxyl groups; and can be C₂ to Ci₈ alkyl, aryl, or alkaryl compounds; or mixtures thereof. The polyhydroxy alcohols may be linear, branched, or cyclic; or mixtures thereof. In a preferred embodiment, the polyhydroxy alcohols may he methylenglycol (MEG), diethylenglycol (DEG), methylpropylenglycol (MPG), dipropyleneglycol (DPG), glycerol, trimethylol propane, (TMP), pentaerythritol, and sugars such as sucrose and sorbitol. In still another preferred embodiment, the polyhydroxy alcohols may be glycerine, glycol, sugars, or mixtures thereof.

A preferred initiator composition, shown in the following Scheme (1), can be the reaction products of MDEA and glycerine:

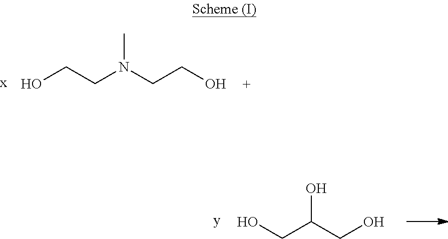

In Scheme (I) above, x is preferably an integer of from 1 to 10 and independently y is preferably an integer of from 1 to 10.

In one embodiment, the reaction product of the dihydroxy tertiary amine and the polyhydroxy alcohol may comprise a mixture of products as well as partially and/or completely unreacted tertiary amine and/or polyhydroxy alcohol. For example, in a preferred embodiment the reaction of N-methyl diethanol amine and glycerine in addition to unreacted. N-methyl diethanolamine and/or glycerine, may yield a mixture of products as described in WO2015/153316 A1, incorporated herein by reference.

In another embodiment, the autocatalytic polyol useful in the process of the present invention is an autocatalytic polyol compound which contains an alkyl amine of within the polyol chain or a di-alkylylamino group pendant to the polyol chain wherein the polyol chain is obtained by copolymerization of at least one monomer containing an alkyl aziridine or

N,N-dialkyl glycidylamine with at least one alkylene oxide, preferably the alkyl or di-alkyl moiety of the amine is a C₁ to C₃ alkyl.

Useful aromatic amine based polyether polyols include those based on 1,2-, 1,3- and 1,4-phenylenediamine; 2,3-, 2,4-, 3,4- and 2,6-toluene diamine (TDA); 4,4′-, 2,4′- and 2,2′-diaminodiphenylmethane (DADPM); and/or polyphenyl-polymethylene-polyamine initiators; and mixtures thereof. The alkoxylated aromatic amine polyols may contain alkoxylation products derived from other ingredients in the initiator mixture. In most cases they contain alkoxylation products of lower molecular weight diols and triols such as diethylene glycol, glycerine and/or water. In addition, the aromatic amine based polyether polyol may contain lower molecular weight diols and triols such as diethylene glycol, dipropylene glycol and/or glycerine. Aromatic amine based polyether polyols such as TDA-based polyether polyols and diaminodiphenylmethane or polymethylene polyphenylene polyamine (DADPM) -based polyether polyols have been described as suitable isocyanate-reactive compounds for rigid polyurethane foams (see, for example, EP421269, EP617068, and EP708127; W094/25514; and U.S. Pat. Nos. 5,523,333, 5,523,332 and 5,523,334.

TDA-based polyether polyols for use in the present invention generally have OH numbers in the range of about 350 to about 810, preferably about 350 to about 470 mg KOH/g, and more preferably about 350 to about 430 mg KOH/g; and have functionalities in the range of from about 3.7 to about 4.0, preferably about 3.9. The molecular weight of the TDA-based polyether polyols is generally between about 280 g/mol to about 640 g/mol. TDA-based polyether polyols having above ranges of functionalities and OH values are well known in the art. The TDA-based polyether polyols which may be used in the present invention can be obtained by the addition of alkylene oxides, such as ethylene oxide and/or propylene oxide to one or more of the various isomers of toluene diamine such as 2,4-, 2,6-, 2,3- and 3,4-TDA. Preferably, 2,3- and/or 3,4-TDA (ortho-TDA or vicinal TDA) may be used as an initiator with up to about 25 wt % of total initiator of meta-TDA (2,4- and/or 2,6-TDA). Vicinal TDA is a pure isomer or mixture thereof, preferably containing about 20 wt % to about 80 wt % 2,3-TDA and about 80 wt % to about 20 wt % 3,4-TDA. Other co-initiators can be used in addition to the above initiator in an amount of up to about 60 wt % based on the weight of total initiator, and preferably between about 5 wt % and about 10 wt %.

The range of the autocatalytic polyols useful in the present invention may be dependent on the desired reactivity profile that is needed. Typically, one or more autocatalytic polyols are present in the B-side material the total amount of the autocatalytic polyol(s) used can be equal to or greater than (≥) about 1 wt %, preferably ≥about 2 wt %, and more preferably ≥about 5 wt % based on the total weight of the B-side material. The total amount of the autocatalytic polyol compound(s) present in the B-side material can be an amount equal to or less than (≤) about 65 wt %, preferably ≤about 60 wt %, and more preferably ≤about 55 wt % based on the total weight of the B-side material. In one preferred embodiment, the amount of the at least one autocatalytic polyol can be from about 1 wt % to about 65 wt %.

Component (b) useful in the present invention can be a grafted polyether polyol, also referred to as a “modified polyol” or “PIPA (Poly Isocyanate Poly Addition) polyol” or “copolymer polyol”. Such polyether polyols have been fully described in the prior art and include products obtained by the in situ polymerization of one or more vinyl monomers, for example styrene and acrylonitrile, in polymeric polyols, for example polyether polyols, or by the in situ reaction between a polyisocyanate and an amino- or hydroxy-functional compound, such as triethanolamine, in a polymeric polyol.

The polymer modified polyols which are particularly interesting in accordance with the invention are products obtained by in situ polymerization of styrene and/or acrylonitrile in polyoxyethylene polyoxypropylene polyols and products obtained by in situ reaction between a polyisocyanate and an amino or hydroxy-functional compound (such as triethanolamine) in a polyoxyethylene polyoxypropylene polyol.

Polyoxyalkylene polyols containing from about 5 percent to about 50 percent of dispersed polymer are particularly useful. Particle sizes of the dispersed polymer of less than

50 microns are preferred. Mixtures of such isocyanate-reactive components may be used as well. Most preferably polyols are used which do not comprise primary, secondary or tertiary nitrogen atoms.

The grafted polyol is typically present in the B-side material an amount ≥about 5 wt %, preferably ≥about 10 wt %, and more preferably ≥about 15 wt % based on the total weight of the B-side material. The grafted polyol is typically present in the B-side material an amount ≤about 50 wt %, preferably ≤about 45 wt %, and more preferably ≤about 40 wt % based on the total weight of the B-side material. In one preferred embodiment, the amount of the at least one grafted polyol can be from about 5 wt % to about 50 wt %.

The B-side material may also include one or more reactive polyether polyols as component (c) including for example a high EO-containing polyol compound. For example, the polyol blend may include a glycerine-initiated polyether polyol. Suitable glycerine-initiated polyether polyols useful in the present invention have been fully described in the prior art and include reaction products of alkylene oxides, for example ethylene oxide and/or propylene oxide, with initiators having a functionality of from 2 to about 8, preferably 3 to about 8, and an average hydroxyl number preferably from about 5 to about 100, more preferably from about 10 to about 80, and more preferably from about 15 to about 60. Of particular importance for the preparation of the flexible polyurethane foams of the present invention are polyether polyols and polyol mixtures having a functionality of from ≥about 3 to ≤about 8. Preferably, the polyol or polyols have an average molecular weight of from about 100 to about10,000; and more preferably of from about 200 to about 8,000.

Suitable initiators for the present invention include: polyols, for example ethylene glycol, diethylene glycol, propylene glycol, dipropylene glycol, butane diol, glycerol, trimethylolpropane, triethanolamine, pentaerythritol, sorbitol and sucrose; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl terminated polythioethers, polyamides, polyesteramides, polycarbonates, polyacetals, polyolefins, polysiloxanes, and mixtures thereof. Still further suitable isocyanate-reactive components include ethylene glycol, diethylene glycol, propylene glycol, dipropylene glycol, butane diol, glycerol, trimethylolpropane, ethylene diamine, ethanolamine, diethanolamine, triethanolamine and the other initiators mentioned before. Mixtures of such isocyanate-reactive components may be used as well. In a preferred embodiment, polyols that do not comprise primary, secondary or tertiary nitrogen atoms can be used in the present invention.

Of particular importance for the preparation of the flexible polyurethane foams of the present invention are polyether polyols and polyol mixtures having a hydroxyl number of ≤about 100, preferably ≤about 80, and more preferably ≤about 60. Hydroxyl number indicates the number of reactive hydroxyl groups available for reaction. It is expressed as a number of milligrams of potassium hydroxide equivalent to the hydroxyl content of one gram of polyol.

Of particular importance for the preparation of the flexible foams are reaction products of alkylene oxides, for example ethylene oxide and/or propylene oxide, with initiators containing from 2 to 8, preferably 3 to 8 active hydrogen atoms per molecule.

Suitable initiators include: polyols, for example ethylene glycol, diethylene glycol, propylene glycol, dipropylene glycol, butane diol, glycerol, trimethylolpropane, triethanolamine, pentaerythritol and sorbitol; polyamines, for example ethylene diamine, tolylene diamine, diaminodiphenylmethane and polymethylene polyphenylene polyamines; and aminoalcohols, for example ethanolamine and diethanolamine; and mixtures of such initiators. Other suitable polyols include polyesters obtained by the condensation of appropriate proportions of glycols and higher functionality polyols with polycarboxylic acids. Still further suitable polyols include hydroxyl-terminated polythioethers, polyamides, polyesteramides, polycarbonates, polyacetals, polyolefins, polysiloxanes, and mixtures thereof. Preferred polyols are the polyether polyols comprising ethylene oxide and/or propylene oxide units and most preferably polyoxyethylene polyoxypropylene polyols having an oxyethylene content of at least about 10 wt %; and preferably from about 10 wt % to about 85 wt %. A preferred isocyanate-reactive component comprises an ethylene-oxide capped polyether polyol.

Typically, the reactive polyether polyol, component (c), may be present in the B-side material in an amount of ≥about 1 wt %, preferably ≥about 1.5 wt %, and more preferably ≥about 2 wt % based on the total weight of the B-side material. The reactive polyether polyol can be present in the B-side material in an amount of ≤about 40 wt %, preferably ≤about 30 wt %, more preferably ≤about 25 wt %, and most preferably ≤about 20 wt % based on the total weight of the B-side material. In one preferred embodiment, the amount of the at least one reactive polyether polyol can be from about 1 wt % to about 40 wt %.

In addition to the blend of polyols, Component (II) may also include (d) at least one reactive catalyst; (e) at least one surfactant; and (f) water; and other optional additives. Component (d) useful in the B-side material of the present invention may include at least one or more reactive catalyst compounds. The reactive catalyst can be selected from any number of known catalyst useful for preparing polyurethane foams including for example (i) a reactive blow catalyst; (ii) a reactive gel catalyst; (iii) a non-emission amine catalyst; (iv) a low emission amine catalyst; and mixtures thereof.

For example, in one embodiment, the catalyst component useful in the B-side material of the foam-forming composition of the present invention can be at least one tertiary amine catalyst, which may be selected from any effective tertiary amine Such selections may typically include for example N-alkylmorpholines; N-alkylalkanolamines; aminoalcohols;N,N-dialkylcyclohexylamines; alkylamines where the alkyl groups are methyl, ethyl, propyl, butyl and isomeric forms thereof; heterocyclic amines; and mixtures thereof. Non-limiting specific examples thereof include 1-methylimidazole, triethylenediamine, tetramethylethylenediamine, bis(2-dimethyl-aminoethyl)ether, triethanolamine, triethylamine, tripropylamine, triisoprpylamine, tributylamine, triamylamine, pyridine, quinoline, dimethylpiperazine, N,N-dimethylcyclohexyl-amine, N-ethyl-morpholine, methyltriethylene-diamine, N,N′,N″-tris(dimethylaminopropyl)-sym-hexahydrotriazine, and combinations thereof. A preferred group of tertiary amines comprises 1-methyl-imidazole, 2-ethyl-4-methyl-imidazole, 2-ethylbutyldiisopropylamine, triethylenediamine, triethylamine, triisopropylamine, and combinations thereof.

The tertiary amine catalyst may be any compound possessing catalytic activity for the reaction between a polyol and an organic polyisocyanate and at least one tertiary amine group. Representative tertiary amine catalysts include for example trimethylamine, triethylamine, dimethylethanolamine, N-methylmorpholine, N-ethylmorpholine, N,N-dimethyl-benzylamine, N,N-dimethylethanolamine, N,N,N′,N′-tetramethyl-1,4-butanediamine, N,N-dimethylpiperazine, 1,4-diazobicyclo-2,2,2-octane, bis(dimethylaminoethyl)ether, bis(2-dimethylaminoethyl) ether, morpholine,4,4′-(oxydi-2,1-ethanediyl)bis, triethylenediamine, pentamethyl diethylene triamine, dimethyl cyclohexyl amine, N-acetyl N,N-dimethyl amine, N-coco-morpholine, N,N-dimethyl aminomethyl N-methyl ethanol amine, N, N, N′-trimethyl-N′-hydroxyethyl bis(aminoethyl) ether, N,N-bis(3-dimethyl-aminopropyl)N-isopropanolamine, (N,N-dimethyl) amino-ethoxy ethanol, N, N, N′, N′-tetramethyl hexane diamine, 1,8-diazabicyclo-5,4,0-undecene-7, N,N-dimorpholinodiethyl ether, N-methyl imidazole, dimethyl aminopropyl dipropanolamine, bis(dimethylaminopropyl)amino-2-propanol, tetramethylamino bis (propylamine), (dimethyl(aminoethoxyethyl))((dimethyl amine)ethyl)ether, tris(dimethylamino propyl) amine, dicyclohexyl methyl amine, bis(N,N-dimethyl-3-aminopropyl) amine, and 1,2-ethylene piperidine and methyl-hydroxyethyl piperazine; and mixtures thereof. Preferred tertiary amine catalysts are one or more of N,N,N′-trimethyl-N′-hydroxyethyl-bisaminoethylether (e.g., catalysts available as JEFI-CAT™ ZF-10 from Huntsman Corporation and as TOYOCAT™ RX 10 from Tosoh Corporation), N,N-bis(3-dimethylaminopropyl)- N-isopropanolamine (JEFFCAT ZR-50), N-(3-dimethylaminopropyl)-N, N-diisopropanolamine (JEFFCAT DPA), 1,3-propanediamine, N′-(3-(dimethylamino) propyl)-N,N-dimethyl (JEFFCAT Z-130), N,N,N′-trimethylaminoethyl-ethanolamine (JEFFCAT Z-110), bis-(2-dimethylaminoethyl)ether (JEFFCAT ZF-20), N,N-dimethylethanolamine (DMEA), benzyldimethylamine (BDMA), N,N-dimethylcyclohexylamine (DMCHA), pentamethyldiethylenetriamine (PMDETA), N,N,N′,N″,N″-pentamethyl-dipropylenetriamine (JEFFCAT ZR-40), dimethylaminopropyl amine (DMAPA), (3-aminopropyl dimethylamine, 1,1′-[[3-(dimethylamino)propyl]-imino]bispropan-2-ol) (JEFFCAT LE-310), NIAX EF 600, DABCO NE 1070; and mixtures thereof.

In one preferred embodiment, the reactive catalyst, component (d), useful in the present invention may include for example a reactive blow catalyst such as ≥90% N-[2-[2-(dimethylamino)ethoxy]lethyl]-N-methyl-1,3-propanediamine (DABCO NE 300 available from Evonik); NIAX EF 100; N,N,N′-trimethyl-N′-hydroxyethyl-bisaminoethylether (available as JEFFCAT™ ZF-10 from Huntsman Corporation); N,N-bis(3-dimethylaminopropyl)- N-isopropanolamine (JEFFCAT ZR 50); and mixtures thereof.

Tertiary amine catalysts are typically used in an amount of from about 0.01 wt % to about 5 wt % based on the total weight of the B-side material. Preferably, the tertiary amine catalyst can be present in the B-side material in an amount of ≥about 0.01 wt %, preferably ≥about 0.1 wt %, more preferably ≥about 0.15 wt %, and most preferably ≥about 0.2 wt % based on the total weight of the B-side material. Preferably, the tertiary amine catalyst can be present in the B-side material an amount of ≤about 5 wt %, preferably ≤about 4.5 wt %, more preferably ≤about 4 wt %, and most preferably ≤about 3 wt % based on the total weight of the B-side material.

Any of the reactive catalyst compounds useful in the present invention may be selected from the above-described compounds including component (d)(i) a reactive blow catalyst such as DABCO NE 300; component (d)(ii) a reactive amine gel catalyst such as DABCO NE 1091; component (d)(iii) a non-emissive amine catalyst such as DMAPA and DABCO NE 210; and component (d)(iv) a low emission reactive amine catalyst, such as DABCO NE 300; and mixtures thereof.

The amount of any one of the above reactive catalyst components (d)(i) to (d)(iv) present in the foam composition, either independently or in combination (total catalyst), can be generally in the range of from about 0.1 wt % to about 5 wt % in one embodiment; from about 0.2 wt % to about 3.5 wt % in another embodiment; and from about 0.3 wt % to about 3 wt % in still another embodiment.

It has been surprisingly found that by combining the catalyst mixture at the high amounts described above and the autocatalytic polyols described above, a fast reactivity profile (while at the same time passing VDA 278 (2015)) and desired processability for the foam of the present invention can be obtained.

In making the polyurethane foam, it is generally preferred to employ an amount of a surfactant, component (e), to stabilize the foaming reaction mixture as the foam expands and until the mixture cures. Thus, the B-side material of the foam formulation may include one or more surfactants. Examples of surfactants useful in the foam formulation include nonionic surfactants (or organo-modified polysiloxanes) and wetting agents such as those prepared by the sequential addition of propylene oxide and then ethylene oxide to propylene glycol, solid or liquid organosilicones, and polyethylene glycol ethers of long chain alcohols; and mixtures thereof. Ionic surfactants such as tertiary amine or alkanolamine salts of long chain alkyl acid sulfate esters, alkyl sulfonic esters, and alkyl arylsulfonic acids; and mixtures thereof can also be used. The surfactants prepared by the sequential addition of propylene oxide and then ethylene oxide to propylene glycol are preferred, as are the solid or liquid organosilicones. Examples of useful organosilicone surfactants include polysiloxane/polyether copolymers such as TEGOSTAB™ B-8729, B-8404, B-8736, B-8870, B 8715 LF2, B-8734LF2, B-8747LF2, B- 8761LF2, and B-8719LF which are available from Evonik; DABCO™ DC -198 which is available from The Dow Chemical Company, NIAX™ L2171 surfactant which is available from Momentive Performance Materials; and mixtures thereof. Non-hydrolyzable liquid organosilicones are more preferred.

Each surfactant is typically present in the foam composition in an amount of ≥about 0.1 wt %, preferably ≥about 0.2 wt %, and more preferably ≥about 0.5 wt % based on the total weight of the B-side material. Each surfactant is typically present in the foam composition in an amount of ≤about 5 wt %, preferably ≤about 2 wt %, and more preferably ≤about 1.3 wt % based on the total weight of the B-side material. In one preferred embodiment, the amount of the at least one surfactant can be from about 0.1 wt % to about 5 wt %.

The B-side material further comprises water, component (f), which performs both a blowing function and/or a chain extension function by reacting with isocyanate groups to generate carbon dioxide and form urea linkages. Water is preferably the sole blowing agent in the foam formulation, although it is possible to include an auxiliary blowing agent within the foam formulation, in addition to the water. The auxiliary blowing agent may be a chemical type such as a carbamate or a physical blowing agent such as, for example, carbon dioxide or a low-boiling hydrocarbon, hydrofluorocarbon or hydrochlorofluorocarbon. In the preferred embodiment in which water is the sole blowing agent, the amount of water is an important contributing factor to the density of the resulting foam.

The water is typically present in the foam composition in an amount of ≥about 1 wt %, preferably ≥about 2 wt %, more preferably ≥about 3 wt % based on the total weight of the B-side material. The water is typically present in the foam composition in an amount of ≤about 15 wt %, preferably ≤about 10 wt %, more preferably ≤about 5 wt % based on the total weight of the B-side material. In one preferred embodiment, the amount of water present in the foam composition can be from about 1 wt % to about 15 wt %.

Not to be held to any specific theory, it is theorized that the ability to produce the low emissions flexible polyurethane foam of the present invention with the advantageous properties may be due to the particular unique combination of compounds described above.

Other additional optional compounds or additives, component (g), may be added to either the A-side material and/or the B-side material as desired. One or more additional types of other optional materials may be used to make the foam-forming composition or to impart desired characteristics to the resulting foam. For example, the optional materials may include catalysts, blowing agents, cell openers, surfactants, crosslinkers, chain extenders, fillers, colorants, flame retardants, stabilizers, pigments, antistatic agents, reinforcing fibers, antioxidants, fragrances, odor masking agents, preservatives, acid scavengers, aldehyde scavengers, and mixtures thereof.

The amount of the optional component (g) present in the foam composition can be generally in the range of from 0 wt % to about 10 wt % in one embodiment; from about 0.1 wt % to about 8 wt % in another embodiment; and from about 0.2 wt % to about 5 wt % in still another embodiment.

In one broad embodiment, the process for making the reactive foam-forming composition of the present invention may include admixing the A-side material with the B-side material, that is, admixing together (I) an isocyanate-containing material; and (II) a polyol-containing admixture of: (a) at least one autocatalytic polyol; (b) at least one grafted polyol; (c) at least one reactive polyether polyol; (d) at least one reactive catalyst; (e) at least one surfactant; and (f) water.

In a preferred embodiment, the process for making the reactive foam-forming composition of the present invention may include contacting (i) an A-side material comprising, consisting essentially of, or consisting of: (I) an organic isocyanate-containing material, for example a polyisocyanate such as MDI, TDI, or mixtures thereof with (ii) a B-side material comprising, consisting essentially of, or consisting of: (II) an admixture comprising, consisting essentially of, or consisting of: (a) at least one autocatalytic polyol; (b) at least one grafted polyol; (c) at least one reactive polyether polyol; (d) at least one reactive catalyst; (e) at least one surfactant; and (f) water; and optionally (g) one or more additional component, for example selected from a catalyst, a cell opener, a crosslinker, a chain extender, a flame retardant, a filler, a colorant, a pigment, an antistatic agent, reinforcing fibers, an antioxidant, a preservative, an acid scavenger, and/or an aldehyde scavenger. The A-side material and B-side material are mixed together to form a reactive blend generally at a temperature of about 90° C. or lower in one embodiment; from about 10° C. to about 90° C. in another embodiment; from about 10° C. to about 60° C. in still another embodiment; and from about 10° C. to about 40° C. in yet another embodiment.

The A-side material and B-side material are also mixed together at a desired ratio. For example, the A-side material:B-side material ratio can be from about 20:100 to about 80:100 by weight. The B-side material containing the polyol and other compounds can be premixed; and then the premix (B-side material) and the organic polyisocyanate component (A-side material) may be mixed together by any known urethane foaming equipment. Mixing together the A-side material with the B-side material to form the reactive formulation, in turn, allows for the foaming reaction to occur which ultimately forms a cured flexible polyurethane foam. In general, the components of the polyurethane-foam-forming reaction mixture may be mixed together in any convenient manner, for example by using any well-known processing and mixing equipment for producing polyurethane products.

The FIP polyurethane foam system of the present invention provides a flexible polyurethane foam that exhibits a certain set of required properties such as a fast reactivity profile, good foam flow, a fast demolding time, a good foam quality, and a low emissions behavior such that the foam passes the VDA 278 (2015) emission test. In general, the particular selection and dosage of the catalytic components, such as the blend of autocatalytic polyols present in the foam system, results in a flexible polyurethane foam that exhibits the above desired foam properties or performance. For example, in one embodiment, the selection and dosage of the (a) at least one polyisocyanate compound and/or the (β) at least one prepolymer containing at least one isocyanate group present in the foam system also contributes to achieving the desired foam properties and performance In addition, the foam-forming composition of the present invention prepared by the above process during the reaction of the components in the composition are able to satisfy a broad range of hardness to cover different production lines and requirements

By “fast reactivity”, with reference to a foam-forming composition, herein means the composition exhibits a gel time of ≤about 15 s and a tack free time of ≤about 30 s.

By “good flow”, with reference to a foam-forming composition, herein means the composition exhibits a cavity density of not more than about 60% of the free rise density.

By “fast demolding” herein it is meant that foam parts, produced using the form-forming composition of the present invention, can be removed from a mold and manipulated after a maximum of 20 seconds from the start time of foam injection into a mold.

In addition, the foam-forming composition of the present invention exhibits several enhanced properties including cream time, gel time, rise time, and free rise density. For example, in certain exemplary processes, it is preferable that the polyol-containing component and the isocyanate-containing component begin to foam quickly to provide an initial sag resistance as the polyurethane formation reaction proceeds. One measure of the rapidity of foaming is known as “cream time (CT)”, which is defined as the elapsed time between the dispensing of the isocyanate-containing component and polyol-containing component and the moment when the combined components start to rise as detected by visual observation. Another description of CT is a measure of the time when bubbles start forming in the reaction mixture as detected by visual observation. During the foaming process, the foam-forming formulations or compositions and processes of the present invention described herein will yield foams with a CT that is generally from 0.5 s to about 10 s, preferably from 1 s to about 7 s, and more preferably from 2 s to about 5 s.

In certain exemplary processes, it is preferable that the polyol-containing component and the polyisocyanate-containing component react and gel quickly to ensure that the foam remains substantially contained within a mold or on the substrate of interest. One measure that is useful for characterizing foams is known as the “gel time (GT).” GT herein means a measure of the time when a macroscopic crosslinked network starts to form during the reaction of the reaction mixture. One exemplary method of determining GT comprises dispensing a fixed mass (e.g., 60 g) of foam into a paper cup Immediately following the dispensing step, the edge of a clean wooden tongue depressor is repeatedly contacted with the expanding foam surface. Once a string of material is formed from the combined polyisocyanate component and the polyol containing component, the elapsed time is recorded. The process is preferably repeated several times, and the GT is calculated as the average elapsed time between the dispensing of the polyisocyanate-containing component and polyol-containing component and the formation of a string of material from the combined components. The foam-forming composition of the present invention prepared in the manner described herein exhibits a GT that is generally from about 8 s to about 20 s, preferably from about 9 s to about 18 s, and more preferably from about 10 s to about 15 s.

In certain exemplary processes, it is preferable that the polyol-containing component and the polyisocyanate-containing component react quickly in order to reach the maximum foam expansion in a short time. One measure that is useful for characterizing foams is known as the “rise time (RT).” RT herein means a measure of the time when the foam height is at the 98% of maximum height reached by the foam in an open cup foaming process.

In general, the RT of the foam-forming composition of the present invention prepared in the manner described herein can be from about 15 s to about 35 s, preferably from about 18 s to about 30 s, and more preferably from about 20 s to about 28 s.

As aforementioned, polyurethane foams may be characterized by a density measurement known as “free rise density (FRD).” FRD herein means a measure of the natural density of a minimal hindered rise in an open mold. In certain illustrative embodiments, the foam-forming composition of the present invention exhibits a FRD of generally from about 30 kg/m³ to about 50 kg/m³, preferably from about 33 kg/m³ to about 47 kg/m³, and more preferably from about 37 kg/m³ to about 43 kg/m³.

Free rise density may be determined by weighing a cup of a pre-determined volume (e.g., a 16 fluid oz. cup or 32 fluid oz. cup) and over-filling the cup with foam to create a crown that rises above the cup's rim. The foam is then fully cured for a period of about 15 minutes, and the crown is cut off to ensure that the foam closely conforms to the cup volume. The cup is again weighed with the foam in the cup, and the weight of the foam is determined by calculating the difference between the weight of the foamed cup and the weight of the cup prior to foaming The free rise volume is then determined by dividing the foam weight by the cup volume. To improve the accuracy of the method, a cup of the same model may be pre-weighed and filled to the cup's rim with water, which has a density of 1 g/cm³. The cup may then be re-weighed. The true volume of the cup in cubic centimeters may then be determined by subtracting the weight of the pre-weighed cup from the weight of the water-filled cup. The previously calculated foam weight may then be divided by the true cup volume to obtain the FRD of the foam.

In one broad embodiment, the process for making the foam product of the present invention may include the steps of: (a) providing a reactive formulation including an A-side material and a B-side material; and (b) mixing the A-side material and B-side material forming a reactive blend foam-forming composition; and then (c) subjecting the reactive blend to process conditions sufficient to cure the reactive blend to form a flexible polyurethane foam.

In a preferred embodiment, the foam-forming composition of the present invention is prepared as described above and then the foam-forming composition is subjected to a process such as a curing temperature to form the foam product. For example, in a molding process, the reaction mixture is formed and then dispensed into a closed mold where curing occurs. Enough of the reaction mixture is charged to the mold so that the mixture expands and fills the mold and produces a foam having the aforementioned density. The mold may be preheated, such as to a temperature of from about 20° C. to about 80° C. The filled mold may be further heated, such as by placing the filled mold into an oven to cure the foam. Such a process is commonly known as a “hot molding” process. In a preferred process, the foam formulation is allowed to cure in the mold without further heating (a “cold mold” process). The mixture is cured in the mold until the cured mixture can be removed without damage or permanent distortion. The demolded foam can be post cured if desired.

Freshly prepared polyurethane foams often exhibit the typical odor of amines and give rise to increased fogging and emission of volatile organic compounds (VOC). For car interior applications, for example, amine emissions from polyurethane foam are undesirable and some car manufacturers request that all VOCs be significantly reduced. The flexible polyurethane foam products produced by the process of the present invention have several benefits over the known foams including for example, a reduction of VOC and FOG, as measured according to VDA 278 (2015). Another advantage of the present invention is that the foams exhibit fast demolding time associated with Low Emission and broad processability.

In one embodiment, the foam made in accordance with the present invention has low emission behavior sufficient to meet VDA 278 (2015) emissions test which includes a VOC upper maximum target of less than (<) 250 ug/g and a FOG upper maximum target of <400 ug/g.

In another embodiment, the foam made in accordance with the present invention has a demold time (fast demolding) of ≤about 20 s.

In addition, the foam made in accordance with the present invention is of a resilient flexible type and advantageously has a core density in the range of from about 35 kg/m³ to about 70 kg/m³, preferably from about 40 kg/m³ to about 60 kg/m³, more preferably from about 45 kg/m′ to about 55 kg/m′, and most preferably from about 47 kg/m′ to about 53 kg/m′. Density is conveniently measured according to the procedure described in ISO 3386-1.

Another advantage of the present invention is that the foams exhibit low compression sets. The lower compression sets are seen in both “dry” and “wet” compression set testing.

Still another advantage of the present invention is that the foams exhibit a broad hardness range, achieved through working within a broad mixing ratio (Iso index) range. This allows to satisfy more than one OEM specification requirement (e.g., a multipurpose system, suitable to be used in more than one production line).

Even still another advantage of the present invention is that the foams exhibit several beneficial physical properties when using a combination of the autocatalytic polyols and the Low Emission catalyst as described above including for example the proper curing and the absence of post demolding deformation even at the lowest demolding time (e.g. 20 s).

In one general embodiment, the polyurethane foam-forming composition of the present invention can be used to prepare foams which may be useful in filling, reinforcing, sealing, and/or acoustic damping applications. For example, in one embodiment of the present invention, the foam-forming composition can be used to prepare foams for automobile interior headrest and armrest applications. The foam made in accordance with the present invention may also be useful in a variety of packaging, seating, and other cushioning applications, such as mattresses, transportations furniture and trims, furniture cushions, automotive seating, bumper pads, sport and medical equipment, helmet liners, pilot seats, earplugs, and various other noise and vibration dampening applications. For applications where the polyurethane foams of the present invention are used, the foams offer fast demolding, processability, and low emission benefits.

### EXAMPLES

The following examples are presented to further illustrate the present invention in detail but are not to be construed as limiting the scope of the claims. Unless otherwise stated all parts and percentages are by weight.

Various terms and designations used in the examples are explained hereinbelow.

VOC stands for volatile organic compounds.

SPECFLEX* NC 138 is a glycerine-initiated, polyoxyethylene-capped polyoxypropylene polyol, having an equivalent weight of about 2040, a nominal functionality of about 3.0, a polyoxyethylene capped percentage of about 15%, and a hydroxyl number of about 28; and is available from The Dow Chemical Company.

SPECFLEX NC 701 is a grafted polyether polyol containing copolymerized styrene and acrylonitrile, with an OH No. of 19-25 mg KOH/g; and is available from The Dow Chemical Company.

SPECFLEX ACTIV 2306 is an amine-initiated, autocatalytic polyether polyol, having a nominal functionality of about 4 and a hydroxyl number of between 31.0 and 40.0; and is available from The Dow Chemical Company.

SPECFLEX NC 632 is a sorbitol/glycerine-initiated, polyoxyethylene-capped polyoxypropylene polyol, having an equivalent weight around 1725, a nominal functionality of around 4.7, a polyoxyethylene capped percentage around 15%, and a hydroxyl number of around 32; and is available from The Dow Chemical Company.

SPECFLEX NE 1150E, SPECFLEX NE 434, SPECFLEX NE 371 are MDI based prepolymers; and are available from The Dow Chemical Company.

VORANOL VORACTIV* VM 779 is an amine-initiated, autocatalytic polyoxyethylene-capped polyoxypropylene polyol, having an equivalent weight of about 1,700, a nominal functionality of about 4, a polyoxyethylene capped percentage of about 17.5%, and a hydroxyl number of about 33; and is available from The Dow Chemical Company.

VORANOL* CP 1421 is a glycerine-initiated, polyoxyethylene/polyoxypropylene-capped polyoxypropylene polyol, having an equivalent weight of about 1675, a nominal functionality of about 3.0, a polyoxyethylene/polyoxypropylene capped percentage about 80% , and a hydroxyl number of about 33; and is available from The Dow Chemical Company.

DEOA stands for diethanolamine which is a crosslinker available from Aldrich.

DMAPA stands for dimethylaminopropyiamine which is a reactive amine catalyst available from Huntsman Corporation.

DABCO NE 210 is a balanced and reactive non-emissive amine catalyst; and is available from Evonik.

TOYOCAT RX20 is an amine emission free catalyst available from Tosoh Corporation.

DABCO NE 1091 is a reactive amine gel catalyst; and is available from Air Products.

DABCO NE 300 is a low emission (mainly blowing) reactive amine catalyst; and is available from Evonik.

TEGOSTAB B 8715 LF2 is a surfactant; and is available from Evonik.

### Test Methods

Gel time tests, cream time tests, rise time tests, and free rise density tests were each conducted according to the procedures described herein above. VOC emission tests and FOG emission tests were conducted according to the procedure described in VDA 278(2015).

### Examples 1-4 and Comparative Example A

The Examples described in Table I include a formulated polyol blend reacted with MDI. The MDI has an isocyanate content as described in Table I. The polyol blend (B-side material) and polymeric MDI (A-side material) are mixed in a polyurethane dispense machine. This dispense machine is a standard machine that is available in the market for example from equipment Suppliers like Henneke, Krauss Maffei and Cannon. In the Examples prepared as described in Table I, the formulations were subjected to the following processing conditions:

The dispense machine is capable of mixing a given foam-forming system at a given ratio of isocyanate to polyol. The ratio is controlled by the pump/motor size. The dispense temperature of the material is generally in the range of from about 15° C. to about 50° C. In the Examples, the temperature of the polymer T (poly) was 20° C. and the temperature of the isocyanate T (iso) was 20° C.

The dispense pressure, at the 20° C. material temperature, is generally in the range of from about 100 bar to about 200 bar. In the Examples, the pressure of the pressure of the polymer was 170 bar and the pressure of the isocyanate was 170 bar.

Generally, material dispense flow rate is in the range of from about 50 g/s to about 800 g/s at the mix-head. In the Examples, the output flow rate was 150 g/s.

The shot weight was 230 g.

The mixing ratios by weight of the polyol mixture (poly) to prepolymer isocyanate (iso) for each of the Examples are described in Table I.

For the Examples described in Table I, the formulated A-side material (comprising isocyanate and other additives) and B-side material (comprising a polyol blend and other additives) is made from the components described in Table I. Amounts are given as weight percent based on the total weight of the A-side material or B-side material, respectively.

Comparative Example A was tested in a customer plant and the foam system of Comparative Example A performed poorly, i.e., the foam exhibited a fast demolding time but the foam did not exhibit Low Emission. Another issue faced in the customer plant trial is that the material of the foam system of Comparative Example A could not be used for new Low Emission production because foam systems for serial production have significant differences in required properties, hence a foam system product needs to be “multipurpose”. The formulation of Example 4, as described in Table I, satisfied the specific application requirements including the reactivity profile (i.e., gel time, rise time, and demolding time), the emission behavior and the suitability to cover hardness requirements of all production line tested with Example 4.

The polyol mixtures, the prepolymer, and the ratio of polyol mixture:prepolymer for the systems of Example 4 and Comparative Example A are considerably different. The following compositional changes were implemented in the system of Example 4 to fix the processability problems exhibited by the system of Comparative Example A: (1) DABCO NE 300 was introduced and its quantity tuned which led to faster creaming and, in turn, reduced the backflow from the injection point; (2) the amount of DMAPA/DABCO NE 210 was adjusted which in turn allowed a more regular curing profile; (3) DABCO NE 1091 was introduced and its quantity tuned which in turn allowed a more regular curing profile; (4) the amount of silicone was reduced, and with the reduction, combined with prepolymer change (SPECFLEX NE 371),

TABLE I
Reactive Foam Formulations

| | | Comparative | | | | |
|---|---|---|---|---|---|---|
| Formulation Component | Function of Component | Example A | Example 1 | Example 2 | Example 3 | Example 4 |
| VORANOL VORACTIV | Autocatalytic Polyol | 25 | 43.60 | 42.15 | 41.80 | 42.00 |
| VM 779 | | | | | | |
| SPECFLEX ACTIV 2306 | Autocatalytic Polyol | — | 10.00 | 10.00 | 10.00 | 10.00 |
| SPECFLEX NC 701 | Grafted Polyether Polyol | 35 | 29.00 | 36.00 | 36.00 | 36.00 |
| SPECFLEX NC 138 | Reactive Polyether Polyol | — | 7.00 | — | — | — |
| SPECFLEX NC 632 | Reactive Polyether Polyol | 26.4 | — | — | — | — |
| VORANOL CP 1421 | Reactive Polyether Polyol | 1 | 4.00 | 4.00 | 4.00 | 4.00 |
| DEOA | Crosslinker | 1 | 0.85 | 0.85 | 0.85 | 0.85 |
| DMAPA | Catalyst | 0.5 | 0.50 | 0.50 | 1.20 | 1.00 |
| DABCO NE 210 | Catalyst | 2.8 | 0.30 | 0.30 | 0.30 | 0.30 |
| TOYOCAT RX20 | Catalyst | 3.4 | — | — | — | — |
| DABCO NE 1091 | Catalyst | — | 1.00 | 1.00 | 0.50 | 0.50 |
| DABCO NE 300 | Catalyst | — | 0.40 | 1.00 | 1.30 | 1.20 |
| TEGOSTAB B 8715 LF 2 | Surfactant | 0.9 | 0.50 | 0.50 | 0.30 | 0.30 |
| Water | | 4 | 2.85 | 3.70 | 3.75 | 3.85 |
| Total | | | 100 | 100 | 100 | 100 |

| Prepolymer: SPECFLEX | NE 434 | NE 1150E | NE 1150E | NE 434 | NE 371 |
|---|---|---|---|---|---|
| Target NCO % | 29.65 | 30.15 | 30.15 | 29.65 | 29.80 |
| Mix Ratio Poly/Iso | 100/80 | 100/50-55 | 100/68 | 100/70 | 100/65-90 |

| Test | Test Results: Time (seconds) | | | | |
|---|---|---|---|---|---|
| Cream time (CT) | 4 | 3 | 3 | 4 | 3 |
| Gel time (GT) | 13 | 23 | 16 | 14 | 13 |
| Rise time (RT) | 22 | 35 | 22 | 24 | 26 |
| Free rise density (FRD) | 38 | 48 | 38 | 41 | 39.46 |
| Demolding at 20″ | OK | OK | OK | OK | OK |
| Emission VDA 278 | NO | OK | Not Tested | Not Tested | OK |
| Post demolding deformation/ | OK | NO | NO | NO | OK |
| proper curing | | | | | |
| Hardness (both production | NO | NO | NO | NO | OK |
| lines) | | | | | |

and the post curing shrinkage was reduced; (5) the amount of water was adjusted which in turn assisted in achieving a desired density to cover both low emissions and serial/conventional production requirements; and (6) SPECFLEX ACTIV 2306 was introduced in combination with the other autocatalytic polyol to achieve the desired properties and performances.

Fast demold time is a key feature for the foam systems of the present invention; and the demold times for Comparative Example A and Example 4 were both 20 seconds. However, in the case of Comparative Example A, low emissions requirements could not be met using the composition of Comparative Example A. Curing, demold times and low emissions for Example 4, on the other hand, were all sufficiently adequate.

TABLE II
Emission Test VDA 278 (2015 - Formulation of Example 1

| | | Measured | Requirements According |
|---|---|---|---|
| | | Value | to DBL 5452 (July 2015) |
| Test Parameter | | in μg/g | in μg/g |
| VOC | First Value | 146 | ≤250 |
| | Second Value | 129 | |
| FOG | Total Emissions | 230 | ≤400 |

TABLE III
Emission Test VDA 278 (2015) - Formulation
of Example 4 (mix ratio 100/85)

| | | Measured | Requirements According |
|---|---|---|---|
| | | Value | to DBL 5452 (July 2015) |
| Test Parameter | | in μg/g | in μg/g |
| VOC | First Value | 89 | ≤250 |
| | Second Value | 90 | |
| FOG | Total Emissions | 390 | ≤400 |

TABLE IV
Emission Test VDA 278 (2015) - Formulation
of Example 4 (mix ratio 100/90)

| | | Measured | Requirements According |
|---|---|---|---|
| | | Value | to DBL 5452 (July 2015) |
| Test Parameter | | in μg/g | in μg/g |
| VOC | First value | 87 | ≤250 |
| | Second value | 91 | |
| FOG | Total emission | 262 | ≤400 |

In the above Tables, “VOC” stands for volatile organic compounds; and “FOG” means a fogging value for a foam formulation according to fog testing.

1. A polyurethane foam-forming reaction mixture composition comprising:
(I) an isocyanate-containing material; and
(II) a polyol-containing admixture of:
(a) at least one autocatalytic polyol;
(b) at least one grafted polyol;
(c) at least one reactive polyether polyol
(d) at least one reactive catalyst;
(e) at least one surfactant; and
(f) water;
wherein the foam-forming reaction mixture composition when reacted provides a foam having a demolding time of less than or equal to about 20 seconds and a low emissions value meeting the target value defined in VDA 278 (2015).

2. The foam-forming composition of claim 1, wherein the autocatalytic polyol is an amine-initiated, autocatalytic polyoxyethylene-capped polyoxypropylene polyol.

3. The foam-forming composition of claim 1, wherein the grafted polyol is the result of in situ polymerization of styrene and/or acrylonitrile in polyoxyethylene polyoxypropylene polyols.

4. The foam-forming composition of claim 1, wherein the reactive polyether polyol is a polyoxyethylene -capped polyoxypropylene polyol.

5. The foam-forming composition of claim 1, wherein the reactive blowing catalyst is >90% N-[2-[2-(dimethylamino)ethoxy]ethyl]-N-methyl-1,3-propanediamine.

6. The foam-forming composition of claim 1, wherein the surfactant is an organomodified polysiloxane surfactant.

7. The foam-forming composition of claim 1, including one or more of the following components: a diethanolamine crosslinker; a dirnethylarninopropylarnine reactive catalyst; a non-emissive amine catalyst; and an amine gel catalyst.

8. The foam-forming composition of claim 1, wherein the amount of the at least one autocatalytic polyol is from about 1 weight percent to about 65 weight percent; the amount of the at least one grafted polyol is from about 5 weight percent to about 50 weight percent; the amount of the at least one reactive polyether polyol is from about 1 weight percent to about
40 weight percent; the amount of the at least one reactive catalyst is from about 0.1 weight percent to about 5 weight percent; the amount of the at least one surfactant is from about 0.1 weight percent to about 5 weight percent; and the amount of water is from about 1 weight percent to about 15 weight percent.

9. A process for making a foam-forming reaction mixture composition comprising admixing:
(I) an isocyanate-containing material; and
(II) a polyol-containing admixture of:
(a) at least one autocatalytic polyol;
(b) at least one grafted polyol;
(c) at least one reactive polyether polyol;
(d) at least one reactive catalyst;
(e) at least one surfactant; and
(f) water;
wherein the foam-forming reaction mixture composition when reacted provides a foam having a demolding time of less than or equal to about 20 seconds and a low emissions value meeting the target value defined in VDA 278 (2015).

10. A polyurethane foam article comprising the reaction product of a foam-forming reaction mixture composition comprising:
(I) an isocyanate-containing material; and
(II) a polyol-containing admixture of:
(a) at least one autocatalytic polyol;
(b) at least one grafted polyol;
(c) at least one reactive polyether polyol;
(d) at least one reactive catalyst;
(e) at least one surfactant; and
(f) water;
wherein the foam-forming reaction mixture composition when reacted provides a foam article having a demolding time of less than or equal to about 20 seconds and a low emissions value meeting the target value defined in VDA 278 (2015).

11. The foam article of claim 10, wherein the polyurethane foam has a density of from about 35 kg/m³ to about 70 kg/m³ measured at 23° C. according to ISO 3386-1.

12. The foam article of claim 14, comprising an automotive interior article.

13. A process for producing a flexible polyurethane foam comprising the steps of:
(i) admixing:
(I) an isocyanate-containing material; and
(II) a polyol-containing admixture of:
(a) at least one autocatalytic polyol;
(b) at least one grafted polyol;
(c) at least one reactive polyether polyol;
(d) at least one reactive catalyst;
(e) at least one surfactant; and
(f) water; wherein a reactive foam-forming composition is formed; and
(ii) subjecting the resulting reactive foam-forming composition from step (i) to conditions sufficient to cure the reactive foam composition to form a flexible polyurethane foam wherein the foam-forming reaction mixture composition when reacted provides a foam having a demolding time of less than or equal to about 20 seconds and a low emissions value meeting the target value defined in VDA 278 (2015).

14. The process of claim 13, wherein step (i) and/or step (ii) is carried out at a temperature of from about 10° C. to about 90° C.
